(19) United States
(12) Patent Application Publication
(10) Pub. No.: US 2006/0010151 A1
(43) Pub. Date: Jan. 12, 2006

(54) Lossless compression method and apparatus for data storage and transmission

(76) Inventor: Chih-Ta Star Sung, Glonn (DE)

Correspondence Address: Chih-Ta Star Sung;BLD. 52. RM. 308, NO. 195, CHUNG HSING RD. SEC. 4, CHU TUNG TOWNSHIP, HSINCHU COUNTY, 310, TW

(21) Appl. No.: 10/852,009

(22) Filed: May 25, 2004

(51) Int. Cl. G06F 17/00

(52) U.S. Cl. 707/102

(57) ABSTRACT

The present invention provides method and apparatus of a lossless data compression to reduce the amount of data to be transmitted or to be saved into a storage device. In the VLSI implementation, a data path module combined with some state machines support multiple formats of data file and to execute the function of the lossless data compression. The amount of the program data of a File System is reduced by a lossless compression method before it is saved into the storage device and to be recovered to execute the function of a File System. Before transmission, the data file compressed by the lossless compression algorithm coupled with the corresponding decompression code will be packed into a data stream and the receiving node will recover the data file by executing the decompression code.

### BACKGROUND OF THE INVENTION

1. Field of Invention

The present invention relates to data compression, and more specifically to a lossless text, audio and image data compression method and an apparatus for data storage and transmission, which significantly reduces the amount of data being accesses and transmitted between media devices.

2. Description of Related Art

In the past decades, the benefit of high efficiency of transmission media like xDSL makes Internet and other networking technology prevailingly popular in data communication. The convenience of using Internet and networking has driven more users more frequently to transmit larger data file into Internet which causes “traffic jam” of the networking environments. The growth rate of data being sent to networking like Internet appears to be higher than the growth rate of bandwidth of the transmission media and technology. The method and apparatus of the lossless data compression can reduce the amount of data rate hence make the efficiency of transmission higher and ease the problem of the “traffic jam” in data transmission.

Most semiconductor memories dissipate a certain amount of power during data accessing which include data writing, data erasing, data reading and data retaining. For instance, the DRAM, Dynamic Random Accessing Memory, consumes a lot power since its storage device is mostly likely made of a deep trench capacitor which inherently leaks current all the time once electronic charges are pulled into the capacitor and hence memory cells need to be refreshed from time to time which causes higher power consumption. In an SRAM, the Static Random Access Memory, the junction diodes of each transistor even not that severely leaks current like the DRAM, still leaks about ˜1 uA current every one thousand bits of cells.

Due to the prevailing advantage of no power dissipation during data retaining, the non-volatile memory, NVM has become a popular storage device in mass data storage.

A flash memory is a most commonly used NVM device. A flash memory can be programmed or said written byte by byte or word by word with a length of a word ranging from 8 bits to thousands of bits, while it can be erased only block by block. Which means, during erasure, a whole block data of flash memory cells will be erased. During reading, like most memories, flash memory outputs data byte by byte or word by word with a speed of tens nanosecond per output. In contrast, programming and erasing operations take much longer time in a scale of millisecond to tens of second depends on the block size of memory cells. Due to the need of applying high voltage on the gate and drain or source of the memory cell during programming and erasing, writing or erasing flash memory data consumes much higher power than other memory devices.

The advantage of consuming no power during retaining data drives the flash memory to become a key memory in the mass storage applications. Applications of the mass storage include but are not limited to memory cards like CF, a Compact Flash card, mainly used in digital cameras, SD, a Security Digital card, another popular memory card in digital cameras and USB memory disk, a popular portable memory disk. FIG. 1a illustrates a block diagram of a prior art storage device. A micro-controller 13 residing inside a storage device 12 plays an important role of controlling the data accessing of an external device 11 like PC, Internet, digital camera, mobile phone . . . or other media device. The flash memory controller manipulates and transfers data file into an appropriate location within a flash memory chip 14. This kind of mobile storage device with mass data can be easily carried from a place to another place. A source 15 of data file sends the file of data to the destination 16 through a transmission line 17 which can be an Internet or a networking line. Due to higher growth rate of Internet users and larger data amount of image and audio files, the bandwidth of transmission line appears narrow than required.

Due to the high complexity of manufacturing and limited suppliers, the unit cost of the flash memory is higher than other semiconductor devices. And the end product prices of the mass storage devices like the memory cards and USB memory disk are materially higher.

### SUMMARY OF THE INVENTION

The present invention is related to a method and apparatus of compressing data before transmitting or saving into a storage device which significantly reduces the amount of data needed to be transmitted and stored hence improves the performance of data transmission or writing data to a storage device and reducing the cost of the storage device.

According to one embodiment of the present invention, a lossless compression method is applied to compress and reduce data from a media before sending to a storage device or a transmission line.

According to another embodiment of the present invention, a lossless decompression method is applied to recover data from a storage device or from the end node of a transmission line.

According to another embodiment of the present invention, a lossless compression method is applied to compress and reduce data from a so-called “File System” and store it to a sector of the storage memory.

According to another embodiment of the present invention, a lossless decompression method is applied to recover the data from the storage memory and to be executed by the controller for accurately mapping data from the storage device to the media it accesses.

According to another embodiment of the present invention, a lossless decompression code or execution code is saved into the flash memory, when the storage device is connected to the PC or other media like Internet, TV, radio station or a set-top box, the losssless compression code or the execution code is read out from the flash memory and loaded into the PC or the media to compress those data before sending to the storage device.

According to another embodiment of the present invention, a lossless compression code or its execution code is saved as a software driver and is saved into a PC, when a storage device or a transmission media is connected to the PC or other media for data accessing or transmission, the data file needed to be sent goes through the lossless compression code or the execution code and compressed to be smaller size before storing to the storage device or being transmitted to the destination.

According to another embodiment of the present invention, a lossless decompression code or execution code is saved as a software driver and is saved into a PC, when a storage device or a transmission media is connected to the PC or other media for data accessing or transmission, the data file received from the source of data storage or transmission point goes through the lossless decompression procedure and recovers to be original data file in the point of the destination.

According to another embodiment of the present invention, a certain amount of types of data will be supported and a certain number of state machines are implemented to drive the sequences of the lossless compression procedure according to the types of data file to be stored or transmitted.

According to another embodiment of the present invention, a data path with ALU, arithmetic unit and multiplier is implemented to be shared and to execute the compression operation for each type of data.

It is to be understood that both the foregoing general description and the following detailed description are by examples, and are intended to provide further explanation of the invention as claimed.

### BRIEF DESCRIPTION OF THE DRAWINGS

FIG. 1 shows the prior art of data transmission between two media devices like a PC, Internet or a network.

FIG. 2 depicts the conceptual block diagram of the storage device with the lossless data compression algorithm.

FIG. 3 illustrates the conceptual block diagram of the storage device with software lossless data compression. The lossless data compression code is stored in the flash memory or in the PC or other media where resides the data to be stored into the storage device.

FIG. 4 illustrates a semiconductor chip solution of the lossless data compression which supports a certain amount of data types by using one data path to sequentially compress the coming data before storing it into the flash memory.

FIG. 5 illustrates a block diagram of the data transmission between two devices with “Virtual Windows” functioning the execution of compression and decompression of data file.

FIG. 6 illustrates the data stream packing process of the data file and the execution code.

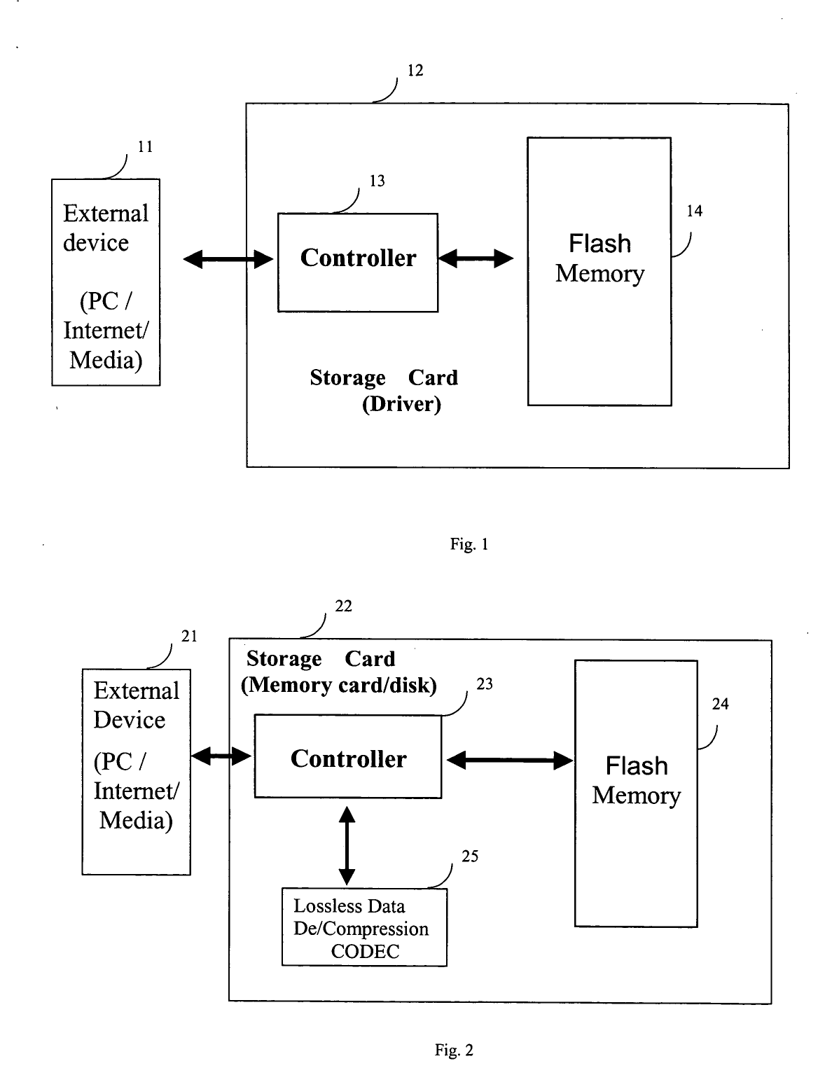

### DESCRIPTION OF THE PREFERRED EMBODIMENTS

The present invention relates specifically to a method and apparatus of lossless compression. The method and apparatus compresses data downloading from a PC, Internet or from a media and store the data to a storage device which results in a significant data reduction and hence reduces the cost of the semiconductor memory or reduces the time or bandwidth of data transmission.

In the past decade, the dropping of the semiconductor memory price and commercialization of some consumers' products which consuming a large amount of memory like digital camera, mobile phone, the mobile storage devices become more popular due to the convenience and portability. The popular mobile storage devices including some memory cards and USB memory drives become prevailingly welcome. Examples of such popular memory cards include CF card, the Compact Flash card, SD card, the Security Digital card, and MM card, the Multimedia card. These cards can be used as a storage devices in digital cameras as well as in mobile phones.

Most semiconductor memories dissipate a certain amount of power during data accessing which include data writing, data erasing, data reading and data retaining. For instance, the DRAM, Dynamic Random Accessing Memory consumes a lot power since its storage device is made mostly of a deep trench capacitor which inherently leaks current all the time once electronic charges are pull into he capacitor and hence memory cells need to be refreshed from time to time which consumes higher power consumption. In an SRAM, the Static Random Access Memory, the junction diodes of each transistor even not that severely leaks current like the DRAM, it still leaks about ˜1 uA current every one thousand bits of cells.

Due to the prevailing advantage of no power dissipation during data retaining, the non-volatile memory, NVM has become a popular storage device in mass data storage applications.

A flash memory is a most commonly used NVM device. A flash memory can be programmed or said written byte by byte or word by word with a length of a word ranging from 8 bits to thousands of bits, while it can be erased only block by block. Which means, during erasure, a whole block data of flash memory cells will be erased. During reading, like most memories, flash memory outputs data byte by byte or word by word with a speed of tens nanosecond per output. While programming and erasing operations take much longer time in a scale of millisecond to tens of second depends on the block size of memory cells. Due to the need of applying high voltage on the gate and drain or source of the memory cell during programming and erasing, writing or erasing flash memory data consume much higher power than other memory devices. As a storage device in mass data storage, the flash memory has high probability of programming-erasing operation and consumes higher power as described above.

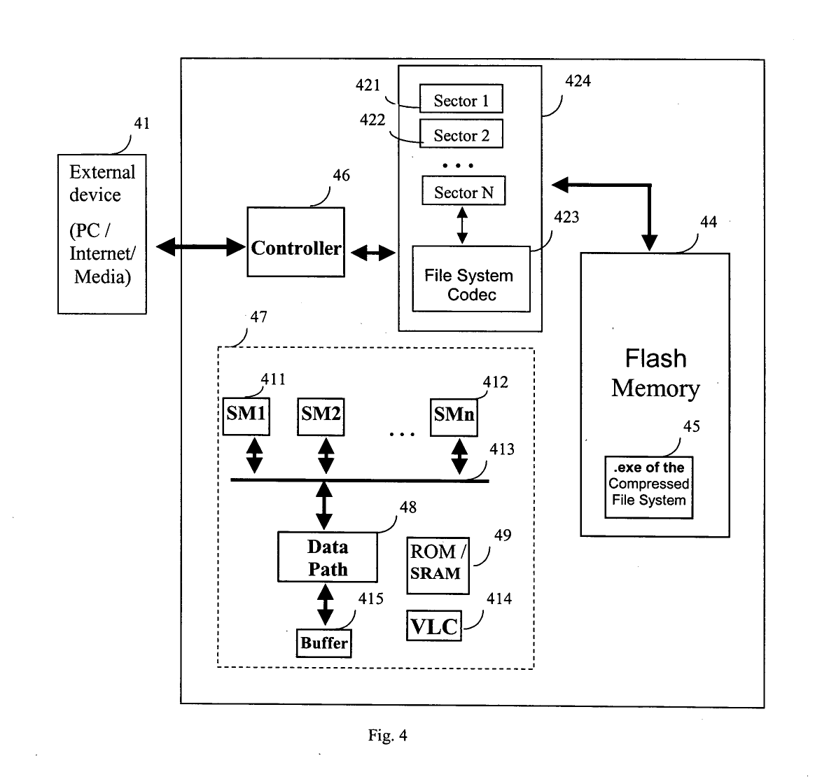

FIG. 2 depicts a conceptual block diagram of an embodiment according to the present invention for the storage device. An example of the detailed hardware implementation is depicted in FIG. 4. The micro-controller 23 residing in a storage card 22 connects between a flash memory and an external device 21 for example a PC, Internet or other media. During down loading data from a PC, Internet or any media, a lossless data compression codec 25 compresses the data received from the micro-controller 23 before sending the data to the flash memory 24 for storage. On the other hand, when reading data from the flash memory, the lossless data compression codec 25 decompresses the data transferring from the flash memory 24 before the data are delivered to the external device 21.

The design of the embodiment as shown in the conceptual figure in FIG. 2 can be implemented by a hardware solution or by a software solution. A software solution is slower than a hardware solution with higher flexibility and free of hardware gate count. While the hardware implementation is faster and dissipates much less power.

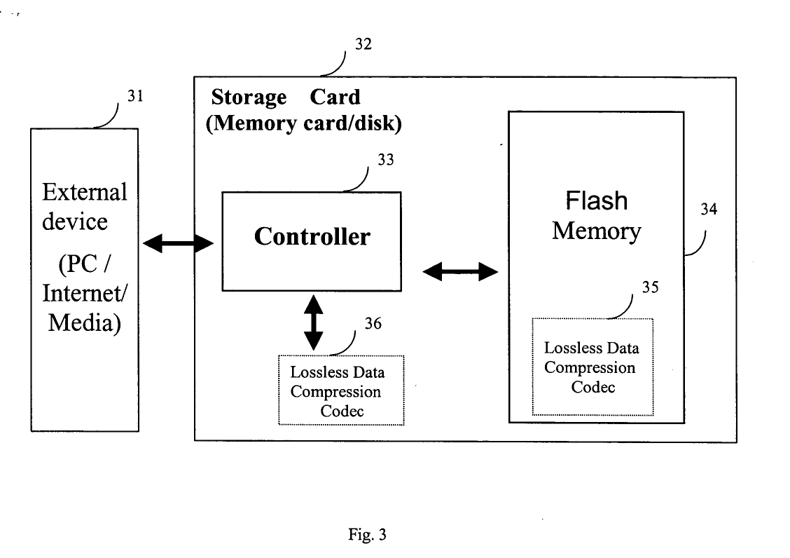

A software solution can be implemented like the block diagram illustrated in FIG. 3. The execution code of the lossless data compression codec 35 can be stored in a sector within a flash memory 34. Before the micro-controller 33 starts loading data from an external device 31 like a PC, Internet or other media, the execution code is loaded to the program cache memory within the micro-controller 33 for the execution of the lossless data compression which is done by the micro-controller. The execution code 35 can also be loaded from the flash memory 34 as the execution code 36 to the external device 31 where the target source data reside if the external device 31 has enough computing power to function the lossless data compression task. The lossless data compression execution code 36 can also be pre-loaded into the external device 31 like a PC, Internet or other media and be executed before loading data to the storage device. Either way, the execution code of the lossless compression codec will compress the target data into a smaller size of file before it is transferred and saved into the flash memory.

In some close system applications, a storage device functions as like it does not matter with any format with external system since the system data format can be unique and the data format within a storage device is defined accordingly. In some system applications, the storage device needs to make the data format storing into the flash memory or reading from the flash memory fully compliant to the file format. In this case, the lossless compression reduces the data amount, but makes the data format twisted and no long the original starting address and end address in the file format. Which in some points need to be corrected in the data recovering.

In the VLSI chip implementation of the storage device control, the high cots of manufacturing the flash memory and high power consumption in writing and erasing data to and from the flash memory, the data compression technique becomes critical in cost reduction. Which means a 4X compression rate saves the flash memory cost by a factor of 4X. Since the external data types might not be known before the data is sent into the micro-controller. For maintaining the data quality and making compliant to most system, lossless data compression algorithm is needed in the storage device application.

Since different data type has different format and very variant in data organization, it is not feasible for a lossless data compression algorithm to support too many types of data. According to the present invention, some popular data types are supported in the lossless data compression. According to a statistically survey, in Windows®' “Word”, “Power Point”, “Notepad” and “Excel” are the most popular document/text file formats. In image file, the “.bmp” is the most popular raw data. In audio file, the “.WAV” is the most popular audio raw data. There are many lossless data compression algorithms been developed and applied to variable applications. The “.AVI” file is a popular audio-video raw data format comprising of a “.WAV” audio raw data and a “.bmp” image raw data. In the feasible hardware implementation, a certain amount of state machines are implemented to control the sequence of lossless data compression based on the data type accordingly.

One of the most popular lossless data compression algorithms is the LZ algorithm which is a dictionary based lossless compression developed by Dr. Lempel and Dr. Ziv. A dictionary based lossless algorithm saves previously pattern into a storage device and compares the coming pattern, if a match, a pair of (starting point, matching length) is assigned to represent the target pattern. Another lossless data compression algorithm is the RAR compression which achieves more than 4X to 10X lossless data compression in “word” and “power point” document data compression. Besides the dictionary based document compression, according to one of the embodiment of the present invention, a proprietary lossless image compression algorithm is developed and applied to compression the .bmp image documents. According to another embodiment of the present invention, a proprietary lossless audio compression algorithm is developed and applied to compress the .WAV raw audio data.

Since the target data file is loaded to the storage device sequentially, no two types of data will be read in the same time. For saving the gate count and the cost of the hardware implementation as shown in FIG. 4, according to an embodiment of the present invention, for efficiency, a module of the “Data Path” 48 is designed to support the common manipulation of the lossless data compression for targeted types of data file. The commonly used “Data Path” includes some functions of arithmetic operation, logic function, a round-shifter and a multiplier. In the lossless data compression engine 47, a state machine 411 is implemented to control the sequence of the data flow of the lossless data compression. Since a centralized larger state machine will cause complexity in managing the state of data condition, according to one embodiment of the present invention, some distributed and smaller state machines are implemented to support more functions of the lossless data compression. For instance, a SM1 411 in this present invention supports the lossless data compression for the “Word”, “Power point”, “Notepad” and “Excel” files by applying the “Dictionary Based” LZ algorithm. A “Dictionary Based” LZ algorithm checks new coming pattern with previously saved “pattern” stored in a “dictionary memory” if there is a match, then the coming pattern is represented by a pointer indicating the location of matching pattern in the location of the “dictionary memory”, if no matching, then the new pattern will be stored into the “dictionary memory” as a previously shown pattern. The SM2, another state machine drives the data path for the lossless “image” data compression. The SMn 412 implements a sequence controlling the lossless data compression for a .WAV file, an audio raw data file. After compression, the compressed data is sent to a semiconductor memory. An NVM is popular for mass storage. An ROM, Read-Only-Memory 49 or an SRAM is implemented to help sequentially operating in the lossless data compression. A VLC, the Variable Length Coding codec 414 is implemented to accelerate the operation of the compression. The Variable Length Coding adopts the concept that uses shortest code to represent the most frequently show up pattern to achieve compression. Since the lossless compression engine 47 reduces the amount of data, the time needed for writing the data into the flash memory is proportionally reduced which results in also a significant reduction in the power dissipation.

For covering more applications, according to an embodiment of the present invention, another lossless data compression engine 424 is implemented to compress the data of the “File System” program before saving it into the flash memory 44. A File System is mainly used to indicate the file format and location of the starting and ending of a file. During data manipulation, the micro-controller copies the compressed “File System” from the flash memory and recover it sector by sector and saves into some temporary buffer 421, 42, 423 sequentially. The execution of the decompressed File System in the temporary buffer can be done sequentially without occupying large amount of buffer, which means a small amount buffer can be used to store a certain length of the File System program and use a buffer fullness or emptiness pointer to indicate the position the program being executing. When the buffer is below a predetermined level, the File System Codec 423 accelerates decompressing the compressed File System Program to avoid potential of emptiness of the program buffer. In a practical implementation, the smaller temporary buffer storing the decompressed File System can be organized as a ping-pong buffer with one buffer is being executing the function of file management, the other is used to receive and save the decompressed File System to accelerate the operation without wait state.

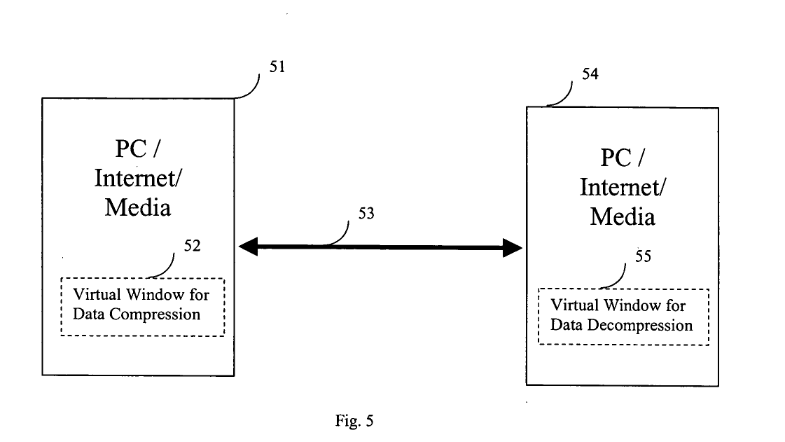

According to another embodiment of this invention in the application of data transmission, before a data file is sent to transmission media like Internet or Ethernet (networking), the data file can be compressed to be smaller amount of data file as shown in FIG. 5. The point of data source can trigger a “Virtual Window” 52, within the “Virtual Window”, the data file goes through a compression procedure before it is sent out to the transmission line 53. After transmitting, the “Virtual Window” in the end of transmission will be automatically disappeared. In the destination point, the receiving machine 54 opens another “Virtual Window” 55 for decompressing and recovering the received compressed data file. After receiving and data file decompression, the “Virtual Window” in receiving point will be automatically disappeared.

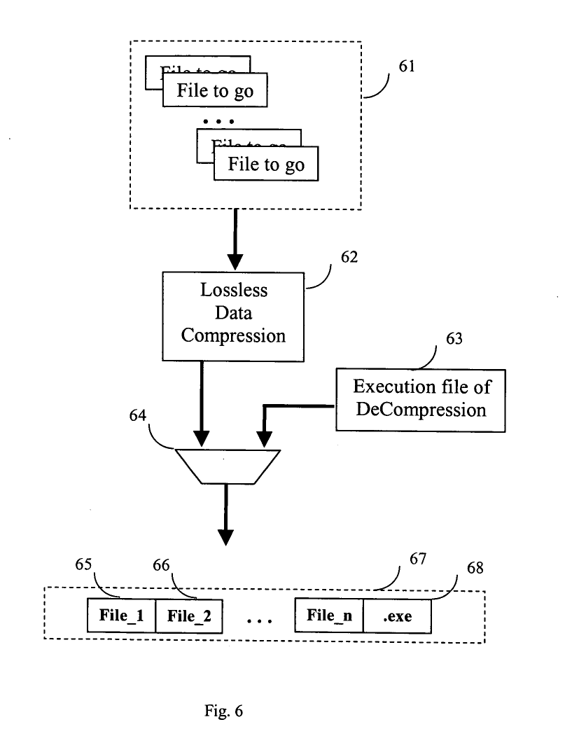

According to an embodiment of this invention, the data files 61 planned to be sent out can be compressed by using the corresponding lossless compression mechanism 62. If the data file(s) is to be sent to the another destination through either Internet or Ethernet they can be compressed 62 and packed by inserting an execution file of a lossless decompression into any predetermined location of the packed data files. The execution file of decompression can include a complete decompression algorithms and can include only corresponding decompression algorithm according to the types of data to be transmitted. FIG. 6 illustrates the compression of data file, packing and inserting the .exe file of the “Decompression” code 63. When the destination receives the stream of data files 65, 66 with an .exe file 68 of the lossless data decompression, it loads the .exe file into a temporary memory by opening a “Virtual Windows” and starts decompressing the data files and saves the recovered data file into an appropriate location.

It is obvious that the lossless data compression method and apparatus of the present invention helps significantly in reducing the amount of data to be stored or to be transmitted. The present invention significantly saves the time of writing data to and reading data from a storage device or through a transmission media which also results in a significant saving of power dissipation.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of performing lossless data compression and decompression for data storage, comprising:
reading a target data file from an external device;
compressing the target data file by a corresponding lossless compression algorithm according to different file formats into compressed data;
storing the compressed data into a storage device;
reading a compressed target data file from a location of a storage memory;
decompressing a target data file by a corresponding decompression algorithm according to different file formats; and
sending the decompressed data into the external device;

2. The method of claim 1, wherein the target data file is selected from a group of a text file, a word, a notepad, a power point, an excel file, an image data file, or an audio data file.

3. The method of claim 1, wherein a micro-controller engine is implemented to control the data flowing between an external device, a semiconductor memory and a lossless compression and decompression engine.

4. The method of claim 1, wherein a storage memory is a flash memory.

5. The method of claim 1, wherein a storage memory is an SRAM or a DRAM.

6. An apparatus of performing the lossless compression algorithms, including:
a data path for executing a lossless compression before storing the data into a memory and a decompression before sending the data to an external device; and
a certain amount of state machines to control the execution of data path and data flow of the corresponding lossless compression algorithms and decompression procedures.

7. The apparatus of claim 6, wherein the data path performs functions of arithmetic operation, logic operation, shifting, rounding and multiplication.

8. The apparatus of claim 6, wherein a small array of storage device is implemented in controlling the procedure of lossless compression and decompression of target data files.

9. The apparatus of claim 6, wherein each state machine controls the data path and combines the data path to perform a lossless compression algorithm in a sequential order of compression for a certain type of target data file.

10. The apparatus of claim 6, wherein a VLC engine, Variable Length Encoder and Decoder, is implemented to accelerate the operation of the lossless data compression.

11. The apparatus of compressing and decompressing a “File System” program, including:
a lossless compression program to reduce an amount of a program file of a File System before storing to a memory device;
a lossless compression engine to execute the lossless compression program to reduce the length and amount of the program file of the File System before storing to a memory device;
a lossless decompression program to recover the File System program before executing the function of the File System; and
a decompression engine to execute the lossless decompression program for recovering the File System before executing the function of the management of a file system.

12. The apparatus of claim 1 1, wherein the lossless compression and decompression program used to compress and decompress the program of a File System is stored in the flash memory device.

13. The apparatus of claim 11, wherein the lossless compression and decompression program used to compress and decompress the program of a File System is preloaded into the target external device.

14. The apparatus of claim 11, wherein a smaller buffer is used to temporarily save the decompressed File System for sequentially executing the function of the file management program.

15. The apparatus of claim 12, wherein the small buffer used to temporarily save the decompressed File System includes a read pointer and a write pointer for monitoring the data fullness and emptiness of the buffer.

16. The apparatus of claim 14, wherein the small buffer used to temporarily save the decompressed File System avoids data emptiness of the buffer and overwriting of the existing program by keeping a certain distance between the read pointer and the write pointer.

17. A method of transmitting and receiving the data file, including:
In the node of transmission:
reducing the amount of data which is to be transmitted by using the corresponding lossless compression algorithms;
inserting an execution file of the data decompression into the stream of data file to be transmitted; and
packing the compressed data and execution code of decompression into a package of data stream.
In the node of receiving:
saving the received data stream into an appropriate location;
decompressing the data stream by executing the received execution code of the data decompression; and
saving the decompressed data file into an appropriate location;

18. The apparatus of claim 17, wherein the complete execution code of the decompression algorithms is inserted into the data file stream no matter what type of data file is to be transmitted;

19. The apparatus of claim 17, wherein only the corresponding execution code of the decompression algorithms is inserted into the data file stream according to the type of data file which is going to be transmitted;

20. The apparatus of claim 17, wherein a “Virtual Window” is opened in the node of the data transmission functioning the corresponding lossless compression of the data files to be transmitted;

21. The apparatus of claim 17, wherein a “Virtual Window” is opened in the node of the data receiving functioning the corresponding decompression of the received data files;
